(19) United States
(12) Patent Application Publication
(10) Pub. No.: US 2025/0263812 A1
(43) Pub. Date: Aug. 21, 2025

(54) METHOD AND APPARATUS FOR PRODUCING TREATED BRINE COMPOSITION WITH REDUCED HYDROGEN SULFIDE

(71) Applicant: ExxonMobil Technology and Engineering Company, Spring, TX (US)

(72) Inventors: Sean A. Mason, Houston, TX (US); Dyan J. Chitty, Selangor (MY); William C. Hicks, Spring, TX (US)

(21) Appl. No.: 19/050,795

(22) Filed: Feb. 11, 2025

Related U.S. Application Data
(60) Provisional application No. 63/554,273, filed on Feb. 16, 2024.

(51) Int. Cl. C22B 26/12; C22B 3/04; C22B 3/22

(52) U.S. Cl. CPC C22B 26/12; C22B 3/04; C22B 3/22

(57) ABSTRACT

A composition, apparatus, and method for enabling improved direct lithium extraction. An exemplary embodiment provides a treated brine composition. The composition includes a treated brine having a concentration of hydrogen sulfide within a range of 0.01 parts per million (ppm) to 500 ppm by weight.

### CROSS-REFERENCE TO RELATED APPLICATION

This application claims priority to and the benefit of U.S. Provisional Application No. 63/554,273, entitled “METHOD AND APPARATUS FOR PRODUCING TREATED BRINE COMPOSITION WITH REDUCED HYDROGEN SULFIDE,” having a filing date of Feb. 16, 2024, the disclosure of which is incorporated herein by reference in its entirety.

### FIELD

The present techniques generally relate to extraction of metals from brines. More specifically, the present techniques are directed towards methods and apparatuses for preparing brine for direct lithium extraction (DLE).

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Metals such as lithium are extracted from different sources for use in various products, including batteries. For example, lithium may take the form of lithium compounds, such as lithium carbonate or lithium hydroxide. Technical grade lithium carbonate is approximately 99% lithium carbonate by weight. The purity standard for battery-grade lithium carbonate may exceed 99.5%.

One available source of lithium is from brines containing lithium among other metals. Such brines may be obtained from various sources. A number of brine sources exist naturally. For example, brine sources include brine deposits like the Salar de Atacama in Chile, Silver Peak Nevada, Salar de Uyuni in Bolivia, the Salar de Hombre Muerte in Argentina, or the Smackover Formation in Arkansas, among other natural deposits.

One currently used method of obtaining metals such as lithium from brines involves the use of solar evaporation ponds. In solar evaporation ponds, evaporation is used to enrich the brine and thus increase the concentration of metals in the brine. Chemical treatments may then be used to purify the brine and reduce impurities. The purified brine may then be converted into a lithium compound via a conversion process. For example, the conversion process may involve the use of a crystallization process to produce the lithium compound. The crystallizers may require a feed brine input with lithium concentrations in excess of about 60,000 parts per million (ppm) and impurity concentration of less than 500 ppm. By contrast, the water chemistry from commercial brine sources may tend to have lithium concentrations on the order of 100-1,000 ppm and a total dissolved solid concentration exceeding 50,000 ppm. Solar evaporation may thus be used to increase lithium concentrations, with chemical treatments to reduce impurities.

However, the usage of solar evaporation ponds may be restricted to use in arid environments that tend to be at high altitudes and remote. Moreover, production time using solar evaporation ponds is long, potentially taking up to 18 months to reach adequate concentrations of lithium or other metals. In addition, solar evaporation has a low selectivity to lithium that requires higher quality brines while recovering less than 50% of lithium. Finally, solar evaporation methods have large land requirements as well as a need for fresh water in arid environments. An improved process of lithium production is desirable.

### SUMMARY

An exemplary embodiment provides a treated brine composition. The composition includes a treated brine having a concentration of hydrogen sulfide within a range of 0.01 parts per million (ppm) to 500 ppm by weight.

Another exemplary embodiment provides an apparatus for brine pretreatment. The apparatus includes a three-phase separator to receive a brine and generate an output liquid with reduced concentrations of hydrogen sulfide and organics. The apparatus further includes a stripper to receive the output liquid from the three-phase separator and further reduce hydrogen sulfide from the output liquid to generate a stream of pretreated brine.

Another exemplary embodiment provides a method for producing direct lithium extraction feeds. The method includes receiving a brine containing hydrogen sulfide. The method also includes pretreating the brine to generate a treated brine with reduced hydrogen sulfide to be used as a direct lithium extraction feed.

Another exemplary embodiment provides a method of using a treated brine composition. The method includes supplying a stream of treated brine composition to a process for mineral extraction, the treated brine composition having a concentration of hydrogen sulfide within a range of 0.01 ppm to 500 ppm by weight.

Another exemplary embodiment provides an apparatus for brine pretreatment. The apparatus includes a flash vessel to receive input brine containing lithium and output vapors containing hydrogen sulfide and a pretreated brine stream. The apparatus also includes a vacuum system coupled to the flash vessel to remove the vapors from the flash vessel under vacuum conditions.

### BRIEF DESCRIPTION OF THE DRAWINGS

The advantages of the present techniques are better understood by referring to the following detailed description and the attached drawings, in which:

FIG. 1 is an illustration of an apparatus for the extraction of lithium from a lithium-containing brine according to embodiments herein;

FIG. 2 is an illustration of an apparatus for the removal of hydrogen sulfide from brines, according to an embodiment;

FIG. 3 is an illustration of an apparatus for the removal of hydrogen sulfide from brines, according to another embodiment;

FIG. 4 is an illustration of an apparatus for the removal of hydrogen sulfide from brines under vacuum, according to another embodiment;

FIG. 5 is a process flow diagram of a method for producing a direct lithium extraction feed, according to another embodiment;

FIG. 6 is a process flow diagram of a method for producing a direct lithium extraction feed, according to another embodiment;

FIG. 7 is a graph depicting an example stripping steam rates for various concentrations of hydrogen sulfide;

FIG. 8 is a graph depicting steam stripping rates for an example packed tower;

FIG. 9A is a graph of brine feed pH impact on hydrogen sulfide stripability; and

FIG. 9B is a detailed graph of brine feed pH impact on hydrogen sulfide stripability.

### DETAILED DESCRIPTION

As used herein, the following terms shall have the following meanings.

As used herein, “brine” or “brine solution” refers to any aqueous solution that contains a substantial amount of dissolved metals, such as alkali and/or alkaline earth metal salt(s) in water, wherein the concentration of salts can vary from trace amounts up to the point of saturation. Generally, brines suitable for the methods described herein are aqueous solutions that may include alkali or alkaline earth metal chlorides, bromides, sulfates, hydroxides, nitrates, and the like, as well as natural brines. In certain brines, other metals like lead, manganese, and zinc may be present. Exemplary elements present in the brines can include sodium, potassium, calcium, magnesium, lithium, strontium, barium, iron, boron, silica, manganese, chlorine, zinc, aluminum, antimony, chromium, cobalt, copper, lead, arsenic, mercury, molybdenum, nickel, silver, thallium, vanadium, and fluorine, although it is understood that other elements and compounds may also be present. Brines can be obtained from natural sources, such as Chilean brines or Salton Sea brines, geothermal brines, Smackover brines, sea water, mineral brines (e.g., lithium chloride or potassium chloride brines), alkali metal salt brines, and industrial brines, for example, industrial brines recovered from ore leaching, mineral dressing, and the like. Brines include continental brine deposits, geothermal brines, and waste or byproduct streams from industrial processes, synthetic brines, and other brines resulting from oil and gas production. In some embodiments, the brines are brines from which energy has already been extracted. For instance, brines used herein include brines from which a power plant has already extracted energy through methods such as flashing.

The term “deep subsurface brine” refers to a saline solution that has circulated through rocks deep in reservoirs such as those found in East Texas, North Dakota, and Arkansas in the United States, and in Alberta, Canada.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “geothermal brine” refers to a saline solution that has circulated through the crustal rocks in areas of high heat flow and has become enriched in substances leached from those rocks. Geothermal brines, such as those found in the Salton Sea geothermal fields, can include many dissolved metal salts, including alkali, alkaline earth, and transition metal salts.

The term “concentrated” in reference to a brine (e.g., “concentrated brine” or “concentrated deep subsurface brine”) refers to brines that have reduced water content compared to the original brine. The reduced water content brine may be subsequently diluted post-concentration to prevent salt precipitation. In some embodiments, concentrated brines can result from various stages used during a DLE process.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity” refers to the extracted lithium per unit of sorbent.

As used herein, precipitates of iron oxides include iron oxides, iron hydroxides, iron oxide-hydroxides and iron oxyhydroxides.

The term “Smackover brine” refers to a type of mineral-rich water that is found in the Smackover Formation, a geological layer that formed during the Jurassic period and spans across several states in the southern United States. Smackover brines are considered a resource for lithium and bromine in particular. Smackover brines may be extracted from the Smackover Formation by pumping them from wells that reach the limestone aquifer. The brines are then processed to separate the lithium and bromine from the water and other minerals.

As used herein, “sour gas” refers to natural gas or any other gas containing significant amounts of hydrogen sulfide (H2S).

The term “treated” in reference to a brine (e.g., “treated brine”) refers to brines that have been processed such that the concentration of at least one metal or elemental component has been reduced in the brine. For instance, a brine in which the concentration of silica and iron has been reduced is a treated brine, also referred to as reduced silica and iron brine.

The term “synthetic brine” refers to a brine that has been prepared such that it simulates a naturally occurring brine. For instance, a synthetic brine can be prepared in an attempt to simulate the brine composition of various geothermal brine reservoirs found in the Salton Sea region (Calif, USA). Generally, the synthetic brine simulating a Salton Sea geothermal brine has a composition of about 280 ppm lithium, 63,000 ppm sodium, 20,000 ppm potassium, 33,000 ppm calcium, 130 ppm strontium, 700 ppm zinc, 1700 ppm iron, 450 ppm boron, 50 ppm sulfate, 3 ppm fluoride, 450 ppm ammonium ion, 180 ppm barium, 160-ppm silica (reported as SiOz), and 180,000 ppm chloride. Additional elements, such as manganese, aluminum, antimony, bromine, chromium, cobalt, copper, fluorine, lead, arsenic, mercury, molybdenum, nickel, silver, thallium, and vanadium, may also be present in the brine.

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Direct lithium extraction (DLE) is a selective lithium extraction process that enables selective recovery of lithium from a complex mineral mix of brine. DLE has lower recovery times in the order of hours or days rather than months. Moreover, DLE enables from 50% to greater than 90% recovery of lithium from brines. In addition, DLE utilizes less land area and can be conveniently deployed anywhere. The present techniques relate to preparing brine so that it is suitable for efficient processing via DLE. The present techniques also generally relate to compositions of treated brine having reduced concentrations of hydrogen sulfide (H2S). The present technological innovation generally relates to compositions for preventing sorbent poisoning and pipe corrosion. These techniques generally relates to treated brine compositions with reduced concentrations of H2S that can also be used for recovery of metals, including lithium, manganese, rubidium, cesium, and potassium.

DLE can be integrated with other technologies for production of lithium product. For example, such technologies may include a precipitator, reverse osmosis, filtration, multi-effect evaporator, and crystallizer, or any combination thereof. Sorption-based techniques are also used for recovery of lithium. For example, a lithium-aluminum-layered double hydroxide chloride sorbent (LAH or AlOH) is sometimes used. DLE today is typically used on salt lake assets. DLE salt lake brine producers make use of evaporation ponds to assist with the pre-treatment, impurity removal, and dewatering, and do not re-inject the water back into the reservoir. However, the water chemistries may have much less impurities than deep subsurface brines because such DLE producers either produce the lithium from the tailings of other brine operations or they target resources for their low impurity concentrations. For example, some producers process their lithium from the brine tailings of their potash operations, which significantly cleans up the water. Some other DLE operations have specifically targeted salt lakes with water chemistries that are more suitable for DLE.

Thus, a different DLE flow may be used on deep subsurface brines as compared to DLE operations with ponds. In particular, the need for impurity removal and dewatering steps may be greater and thus addressed solely with industrial facilities. The key cost drivers may thus be determined by the cost associated with each processing step (i.e. pre-treatment, the DLE step, impurities removal, and dewatering to enhance lithium concentration), and can be categorized as robustness to water chemistry, lithium selectivity, and loading capacity. The three of these processing steps—pre-treatment, impurity removal, and dewatering—are all tied directly to the DLE process, and therefore, the costs are not necessarily independent of one another, as described in greater detail below. Generally, with respect to robustness to water chemistry, the pre-treatment steps prior to DLE must process the largest volume up front, such as chemical treatment or filtration, to remove impurities that cause unsafe operations, scaling issues, or deteriorate sorbent performance.

DLE technology robustness against a wide range of water chemistries can minimize the need for pre-treatment and its cost. With respect to lithium selectivity and loading capacity, the lithium concentrated stream after DLE may still require further refinement to produce a battery grade product, thus necessitating additional post-treatment. The amount of impurities remaining after DLE is determined by the lithium selectivity, while the lithium concentration post DLE is determined by the loading capacity of the sorbent. Post DLE processes are designed to remove residual impurities, boost lithium concentration, and convert to high purity lithium carbonate or lithium hydroxide, and therefore, post-treatment processes will endure more cost for larger quantities of impurities and lower lithium concentrations post-DLE. For example, post DLE processes may include chemical treatments, filtration, dewatering, and crystallization.

While these cost drivers are described independently, they can be highly correlated. For example, lithium selectivity, loading capacity, and robustness may all be tied to the same or correlated physical mechanisms. Another additional complexity is that the mechanisms that enable the use of a particular material in the DLE step to selectively extract lithium rely on thermodynamically favored conditions, and different source brines will be unique in their make-up, and even small differences in water chemistry may alter the thermodynamics in a manner that also influences lithium selectivity and loading capacity. Therefore, these key cost drivers cannot be considered independent of one another or in the absence of the water chemistry under consideration. Therefore, DLE may work best if engineered for a specific lithium deposit. Unlike pond-assisted DLE, the spent brine may also need to be re-injected or cleaned prior to surface discharge.

Accordingly, existing methods for pond-assisted DLE may not work with deep well brines, which may not have been targeted because of the reasons discussed above. In addition, geothermal brines come out at significantly higher pressure and higher temperatures of more than 300 degrees F. Thus, such geothermal brines may not have the same issues of organic matter in the liquid because such organics may flash off with the higher temperatures and pressures and thus not make it into the untreated brine from the geothermal sources. Therefore, such methods may not take the removal of organic matter present in deep subsurface wells into account.

Moreover, regarding pretreatment of brine, some methods aim at removing impurity ions. However, such methods may not fully address the problems present in brines extracted from deep wells. For example, there may be leftover sulfur and organics in such methods, resulting in sorbent being deactivated sooner, plugging downstream of process units, and product being off-specification. Thus, large amounts of organic build-up in the piping or tank system of a lithium extraction facility may have expensive impacts. Additionally, naturally occurring organics may require increased washing in the battery-grade product for a full lithium plant.

Accordingly, embodiments described herein enable improved extraction of lithium and other metals from deep subsurface brines, among other sources of brine. In one embodiment, a direct lithium extraction process is described with improved pre-treatment for reduced poisoning of sorbents and pipe corrosion. A resulting brine composition for improved lithium conversion is also described. The use of such a brine composition may enable increased lithium extraction plant lifetime by reducing the effects of hydrogen sulfide, among other undesirable components. In one embodiment, a method for efficient preparation of a brine feed with reduced hydrogen sulfide, solids, impurities, and organics is described. The techniques described herein thus minimize the amount of entrained sulfur as a result of the vapor phase being present from the original drilling conditions of brine drilled from wells with sour gas. In this manner, the techniques increase the lifetime and spot performance of DLE sorbents used to extract lithium from the resulting pretreated brine stream. Moreover, the pretreated stream generated by the techniques also enable significant corrosion reduction in pipes with continuous processing flows. The techniques also enable the reduction of organics that may be found in brines extracted from deep wells. Thus, the techniques may reduce overall reagent and watering costs.

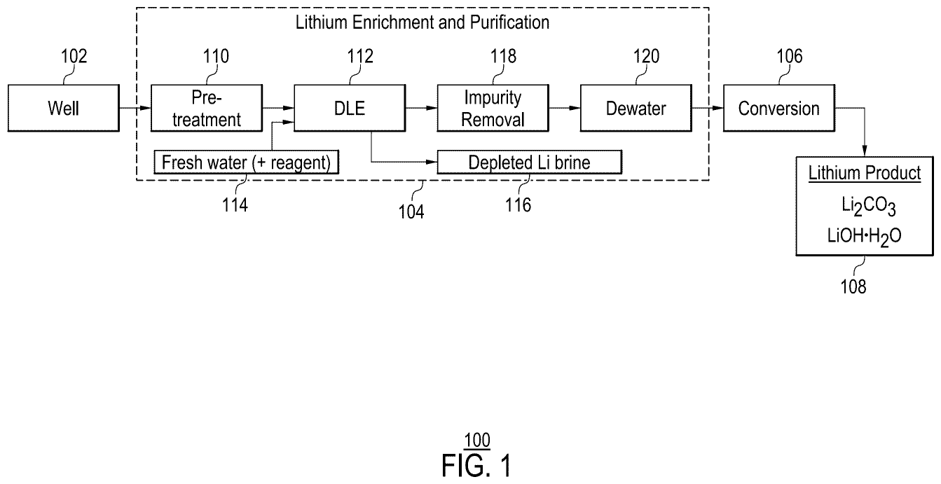

Referring now to FIG. 1, an apparatus 100 for the removal of lithium from a lithium containing brine is provided. A brine containing lithium and other metals is provided via a well 102. The brine received from well 102 may thus be a deep subsurface brine. A lithium enrichment and purification process 104 may then generally purify the brine to produce a purified brine that is sent to a conversion process 106, which converts the brine into a lithium product 108. For example, the lithium product 108 may be lithium carbonate (Li₂CO₃) or lithium hydroxide monohydrate (LiOH H₂O).

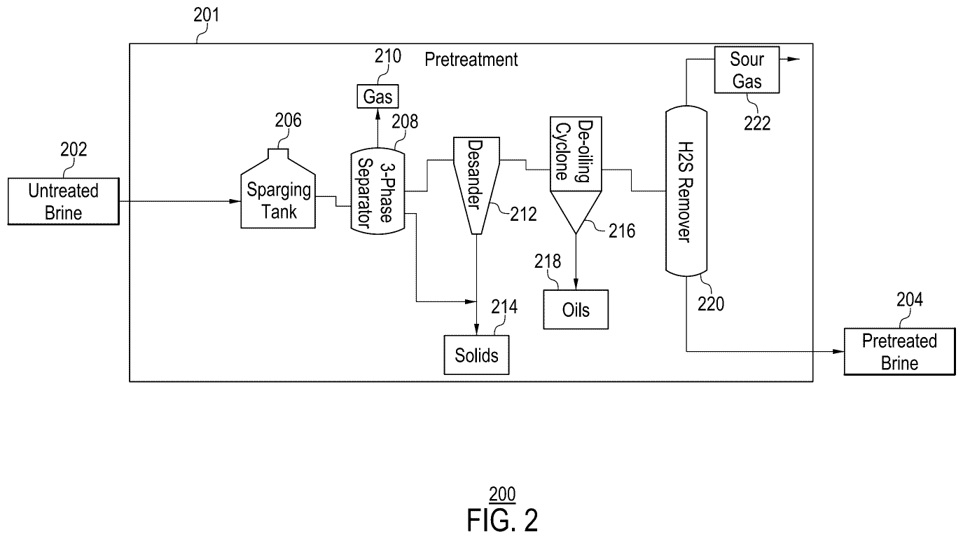

As shown in FIG. 1, the lithium enrichment and purification process 104 includes a pre-treatment process 110. For example, the pre-treatment process 110 may include the use of various technologies, such as the various pretreatment mechanisms and methods of apparatuses 200 and 300 and corresponding methods 500 and 600, described in greater detail with respect to FIGS. 2-6 below.

Pre-treated brine from the pre-treatment process 110 is then processed via a DLE process 112. The DLE process 112 can increase both the ratio of lithium to impurities and the lithium concentration and, regardless of the technique and materials used, this is accomplished by swapping lithium out of the source brine into a fresh water stream 114. In various examples, depending on the techniques applied, additional reagents may also be added to the fresh water stream 114. For example, such reagents may include sodium sulfate (Na2SO4), sodium hydroxide (NaOH), sodium carbonate (Na2CO3), hydrochloric acid (HCl), or sulfuric acid (H2SO4), among other reagents. Each of the steps before and after DLE process 112 are thus tied to the DLE process 112 and the materials used to promote this swap. If impurities in the water would harm the DLE process 112, then these impurities are first removed and this is done in the pre-treatment process 110.

The results of the DLE process 112 is a depleted lithium brine 116 that and a lithium rich water stream that is sent to an impurity removal process 118. In various embodiments, the depleted lithium brine 116 may be deposited back into the well 102. In some embodiments, the depleted lithium brine 116 may be additionally treated before being injected into the well 102. In various embodiments, the spent brine is collected from the DLE process 112 and disposed either onto the surface or re-injected into the subsurface reservoir. For surface disposal, regulatory approval may be required, and depending on location, large quantities of impurities may need to be removed. For reinjection, retention of impurities are required to ensure compatibility with the original subsurface brine. In some embodiments, if too many components are depleted from or added to the spent brine relating to the pre-treatment and DLE processing step, then the spent brine may need to be rebalanced to be compatible with the subsurface brine. Otherwise, an incompatible brine may present a risk of excessive scaling and improper pressure maintenance of the reservoir or well 102.

The impurity removal process 118 removes any remaining impurities in the lithium water stream. For example, there may be some amount of impurities that remain with the lithium after the DLE process 112 because no material and technique that can perfectly select for lithium may exist. Therefore, the post-DLE impurity removal process 118 may be used to remove any such remaining impurities. In various examples, such remaining impurities may include calcium (Ca), boron (B), magnesium (Mg), sodium (Na), strontium (Sr), silicon (Si), zinc (Zn), iron (Fc), potassium (K), argon (Ar), lead (Pb), nickel (Ni), or copper (Cu), among other remaining impurities.

A dewater process 120 receives purified lithium solution from the impurity removal process 118. For example, after the DLE process 112, the lithium concentration may still be less than an example target concentration of at least 60,000 ppm. Therefore, the dewatering process 120 may be applied to remove the water from the purified lithium solution.

In various embodiments, the conversion process 106 then receives purified and concentrated lithium solution from the dewatering process 120 of the lithium enrichment and purification process 104. In some embodiments, once all the above enrichment and purification steps are completed, the lithium enriched brine is fed to the conversion process 106 to produce a saleable battery grade lithium product. For example, the conversion process 106 may include the use of a crystallizer that can generate lithium products such as lithium carbonate, lithium hydroxide monohydrate, lithium sulfate, or lithium phosphate, among other lithium products.

In various embodiments, there thus may be fresh water, chemical, electrical, and sorbent manufacturing requirements to operate a DLE facility using the apparatus 100. In some embodiments, if the apparatus 100 is constructed in a remote location, then delivery of chemicals or sorbents may be unreliable and/or cost of transport of any such chemicals or sorbents may be prohibitive. Therefore, in some embodiments, chemicals and sorbents may also be produced on-site.

FIG. 2 is an illustration of an apparatus 200 for the removal of hydrogen sulfide from brines. The apparatus 200 includes a pretreatment system 201 shown receiving untreated brine 202 and outputting a pretreated brine 204. In various examples, the untreated brine 202 may be produced well water that also contains various ionic impurities including at least magnesium, calcium, sodium, and boron. The untreated brine 202 may also contain poisons such as hydrogen sulfide, among other undesirable components such as solids, impurities, and other organics. In various examples, the untreated brine 202 may have a concentration of hydrogen sulfide in a range of 1 ppm to 30,000 ppm by weight. In some examples, the untreated brine 202 may have a concentration of hydrogen sulfide within a range of 500-10,000 ppm by weight. By contrast, the pretreated brine 204 may have a substantially reduced amount of such undesirable components. For example, the pretreated brine 204 may contain from 0.01 ppm to 500 ppm of hydrogen sulfide by weight. In various embodiments, the exact target amount of hydrogen sulfide in the pretreated brine 204 may depend on sorbent robustness, among other factors, such as sorbent lifetime, pipe corrosion, sorbent selectivity, ion exchange resin lifetime, filter corrosion, etc. In various embodiments, the pretreated brine 204 is a stream that is input into a DLE process, such as the DLE process 112 of FIG. 1.

Still referring to FIG. 2, the pretreatment system 201 includes a sparging tank 206. In various embodiments, air sparging can be used to reduce the amount of hydrogen sulfide in the untreated brine 202. For example, controlling the amount of air injected into the sparging tank 206 can be used to vary the hydrogen sulfide composition in the pretreated brine 204. In particular, the air is used to knockout iron, silica, and entrained gas in the untreated brine 202 via chemical reactions. In various examples, air can be bubbled into the fluid of the untreated brine 202 to precipitate the iron, silica, and remove hydrogen sulfide, among other undesirable components, such as trace amounts of magnesium, calcium, or other ions. In some embodiments, the exact rate of air injection and vessel size of the of the sparging tank 206 can be optimized based on the target composition of the pretreated brine 204. For example, a higher rate of air injection may reduce the amount of hydrogen sulfide remaining in the pretreated brine 204. Similarly, holding the air injection rate constant, a smaller vessel size may reduce the amount of hydrogen sulfide remaining in the pretreated brine 204. Thus, one or more of these factors may be adjusted to result in an optimized composition of hydrogen sulfide in the pretreated brine 204.

The pretreatment system 201 also includes a three-phase separator 208. The three-phase separator 208 is shown receiving the output of the sparging tank 206 and generating gas 210, a partially-treated stream that is sent to a desander 212 for further processing, and solids 214. In various examples, the generated gas 210 may include any combination of methane, ethane, propane, carbon dioxide, and nitrogen, among other gases. In various embodiments, the three-phase separator can remove organics and solids 214 from the bottoms. For example, there may be one or more organics in the brine feed from produced wells that could cause plugging, sorbent deactivation, or cause a product to be off-specification. Example solids that may be removed include any solidified sulfates, phosphate, carbonates, silicas, sands, dirt, etc. Example organics that might be removed via the three-phrase separator 208 include methane, ethane, propane, butanes, pentanes, hextanes, heplanes-plus, carbon dioxide, hydrogen sulfide, pentanes-plus, etc. The three-phase separator 208 can thus be used to remove various gases 210, including hydrogen sulfide gas, as well as solids 214. In some embodiments, the three-phase-separator can remove entrained gases such as natural gas, hydrogen sulfide, and organics/oils that could have been in the underground source. In some examples, the three-phase separator 208 may include a baffle or level control to make sure the phases are properly separated. Liquid water may come from the bottoms, which is the lowest stream in the bottom of a unit. In various examples, the bottoms may either be a solids draw from a filter, or a water stream. The bottoms have a higher density than the gas and organics streams referred to as “the overhead” and “side stream”, respectively. Thus, in various embodiments, the organics may usually settle on top and side draws may be located in each phase region to remove liquid water out of the stream.

In various embodiments, the exact size of the vessel for the three-phase separator 208 and its internals are subject to optimization. For example, the size of the vessel and various components may be designed based on the composition of the untreated brine 202 and the target composition for the pretreated brine 204. In various examples, the three-phase separator 208 may reduce the hydrogen sulfide concentration to within the approximate range of a hundred to a few hundred ppm by weight. In some examples, the three phrase separator 208 may also include de-oiling. For example, the three phrase separator 208 may use density differences to remove oils from the stream. In some embodiments, an additional solvent extraction may also be used to further remove oils. For example, a solvent may be run through the water that picks up the organic phase to remove oil. From a thermodynamic perspective, organics or other oils have a higher affinity for the solvent phase than the liquid phase.

In some embodiments, the pretreatment system 201 further includes the desander 212 to remove additional solids 214 from the liquid mixture received from the three-phase separator 208. In various examples, the desander 212 may use a cyclone and centrifugal force to separate larger solids from brine droplets. For example, such larger solids may include various larger particles, such as sand or bits of rock on the scale of micrometers in size.

In some embodiments, the pretreatment system 201 further also includes a de-oiling cyclone 216 to remove oils 218 remaining in the output stream received from the desander 212. For example, the de-oiling cyclone may use centrifugal force resulting from a density difference between oils and other liquids to remove oils from the output stream received from the desander 212. The de-oiling cyclone 216 may thus be an additional cyclone removal for more trace oil from the brine stream. In various examples, such trace oils 218 may include acetate, propionate, glycolate, formate, among other potential trace oils 218.

In various embodiments, the pretreatment system 201 further also includes a hydrogen sulfide remover 220 to produce gas 222 and pretreated brine 204. For example, the hydrogen sulfide remover 220 may be a stripper. In some embodiments, the hydrogen sulfide remover 220 may be a steam stripper. A steam stripper allows for hydrogen sulfide to be stripped out of the liquid phase and into the gas phase where it will exit the top of the tower while the brine goes to the bottom. In particular, solubility of gas is determined by the partial pressure of the gas in the fluid. Steam strippers run hot water in the vapor phase through the column. When this happens, the total vapor phase has a decrease in hydrogen sulfide content. In particular, the mass does not change, but the concentration of hydrogen sulfide. So, the partial pressure in the vapor phase drops. Additionally, a higher temperature changes the phase behavior to allow better kinetics of stripping A steam stripper takes advantage of this and can vary how much steam is run to vary the partial pressure of H2S in the vapor phase, and by proxy, the total concentration. For example, depending on the pH of the brine, steam can be run through a packed column to strip off the hydrogen sulfide in the brine. In various embodiments, the pH of the brine may be kept low at a more acidic level in order to minimize operating expenses and the size of the tower. For example, hydrogen sulfide is thermodynamically and kinetically more likely to be stripped away by steam at more acidic pH values. In various examples, acids such as hydrochloric acid or sulfuric acid may be added to reduce the pH of the stream. In various embodiments, the rate of steam, height of packing, and tower diameter can be optimized, as these factors may impact mass transfer rates and utility costs depending on the amount of steam. In some embodiments, the hydrogen sulfide remover 220 may be a gas stripper. For example, natural gas can be used in lieu of steam to strip off hydrogen sulfide. In particular, gas stripping may be used to reduce costs, such as when natural gas is readily available to be produced from the ground. In various embodiments, similar optimizations may also be made for a gas stripper as for a steam stripper.

FIG. 2 is not intended to indicate that the apparatus 200 necessarily includes all elements shown therein, and, in various embodiments, additional elements may be included. For example, hydrogen sulfide removal methods are not subject to only the processes shown above. In some embodiments, other methods that can be added or some of the components can be removed depending on the required hydrogen sulfide specification for the process. In various embodiments, the apparatus 200 produces a stream that is the cumulative result of any number of processing steps executed to reduce hydrogen sulfide for the purposes of lithium extraction.

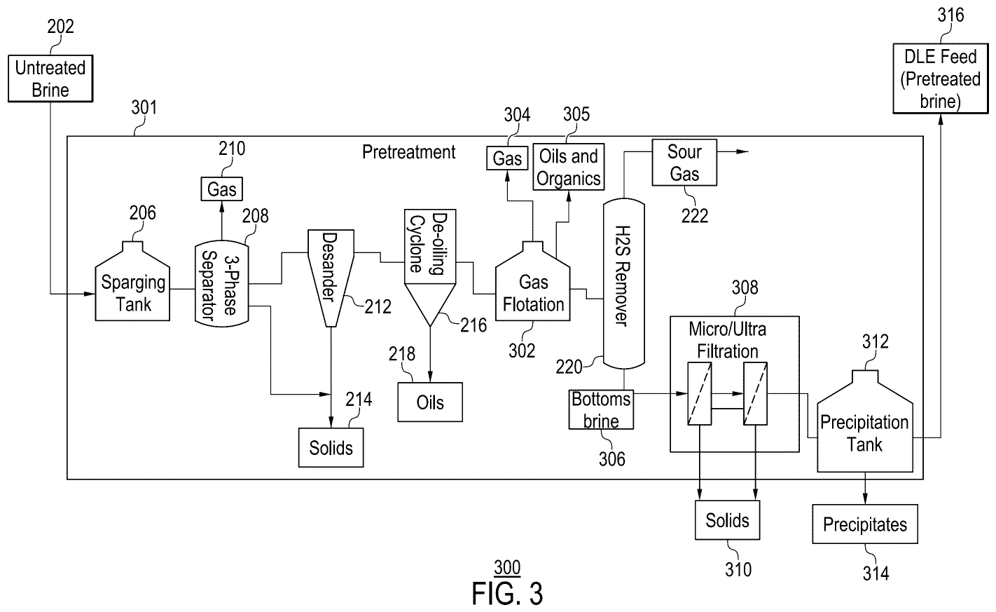

FIG. 3 is an illustration of an apparatus 300 for the removal of hydrogen sulfide from brines. The apparatus 302 includes a pretreatment system 301. The pretreatment system 301 includes similarly referenced elements of FIG. 2. For example, the pretreatment system 301 includes a sparging tank 206 that can similarly be used to remove hydrogen sulfide. The pretreatment system 301 also includes a three-phase separator 208 that can similarly remove gas 210 and solids 214 from the output stream of the sparging tank 206. The pretreatment system 301 includes a desander 212 to remove additional solids 214 and a de-oiling cyclone 216 to remove additional oils 218.

The pretreatment system 301 additionally includes a gas flotation tank 302 that uses gas 304 to remove oils and organics 305. For example, the gas flotation tank 302 may use gas 304 bubbled through a fluid to force oils and organics 305 to a higher level than water or brine. For example, the oils and organics 305 may include acetate, propionate, glycolate, formate, among other oils and organics. The oils and organics 305 may thus be pushed by the gas to a separator at the top of the gas flotation tank 302 and thus physically separated from the rest of the brine. The gas flotation tank 302 may thus produce gas 304 and oils/organics 305 as byproducts. In various embodiments, and as also shown in FIG. 3, the gas flotation tank 302 receives a liquid feed that has been processed by at least the three-phase separator 208. In the example embodiment of FIG. 3, the liquid feed has additionally first been filtered by the desander 212 and the de-oiling cyclone 216.

In the example of FIG. 3, the output from the gas flotation tank 302 is processed by a hydrogen sulfide remover 220 to output gas 222 and bottoms brine 306. For example, the hydrogen sulfide remover 220 may use a stripper, such as a steam stripper or gas stripper, as described in greater detail above with respect to FIG. 2.

The pretreatment system 301 also additionally includes a micro/ultrafiltration device 308 to remove additional solids 310 from the bottoms brine 306. In various embodiments, the micro/ultrafiltration device 308 is a system of micro/ultrafiltration units configured to remove larger solids from nanometer sized ions dissolved in solution. For example, microfiltration may include removal of particles of size within the range of microns. As one example, microfiltration may physically remove suspended solids from the brine through a membrane having a pore size of approximately 0.1 micron. In various examples, ultrafiltration may include the removal of particles in the size range of sub-microns in size. For example, ultrafiltration may membranes with pore size of approximately 0.01 micron. The membranes of both microfiltration and ultrafiltration may allow nanometer sized ions that are dissolved in the brine to pass through. In various examples, the permeate of the filtration systems can be fed in parallel or series in a mainly liquid phase to a downstream filter.

The pretreatment system 301 of FIG. 3 also further additionally includes a precipitation tank 312 to remove precipitates 314 from brine stream received out of the micro/ultrafiltration 308. In various embodiment, the precipitation tank 312 is used to remove large amounts of solids, such as barium, strontium, any remaining iron, or any number of sulfates, etc. For example, precipitation may be used to remove various impurities, such as barium chloride or strontium sulfate. In some embodiments, the precipitated solids are then removed via a drain. The specific solids removed may depend on the particular reagent or combination of reagents used. As one example, sulfate may be added as a reagent to remove barium. The liquid phase exiting the precipitation tank 312 can be fed to a next downstream unit or to a DLE unit. The resulting pretreated brine may be a liquid-phase, aqueous, lithium containing solution that can be used as a less corrosive and less poisonous DLE feed 316. For example, the DLE feed 316 may have within a range of 0.01 ppm to 500 ppm hydrogen sulfide, such as hydrogen sulfide levels down to 5 ppm or less by weight. In particular, the levels of hydrogen sulfide may have been reduced to these levels by the H2S remover 220. Examples of ranges of hydrogen sulfide levels that may be obtained using the present technological innovation include between 0 ppm and 5 ppm, between 5 ppm and 10 ppm, between 10 ppm and 100 ppm and between 100 ppm and 500 ppm, to name a few non-limiting examples.

In addition, the DLE feed 316 may have organics concentrations in a range of 0-10,000 ppm by weight. In various examples, the resulting final solution can then be sent to either DLE or further bulk removal steps. For example, the DLE feed 316 may be input into the DLE process 112 of FIG. 1 for lithium extraction.

The example illustration of FIG. 3 is not intended to indicate that the operations of the apparatus 300 are to be executed in only one particular order, or that all of the operations of the apparatus 300 are to be included in every case. For example, in some embodiments, the precipitation tank 312 or a second precipitation tank (not shown) may be arranged to process the stream before the micro/ultrafiltration 308. Additionally, the apparatus 300 can include any suitable number of additional operations. In some embodiments, multiple precipitation stages may be used, in which sulfates, carbonates, or caustic are added in separate vessels. In some embodiments, additional filtration may be included before, after, or instead of, precipitation. For example, one filtration may be included to remove sand, dirt, or other particles before precipitation. Another filtration may be included to remove any suspended solids after precipitation. In some embodiments, a nanofilter may be used in lieu of precipitation. For example, nanofilters are like microfilters but have smaller holes so they reject divalent ions such as calcium or magnesium, but let lithium pass through. Nanofilters have no cost of reagents, no additional volume swell (watered down reagent) that needs to be removed later, and no solids waste.

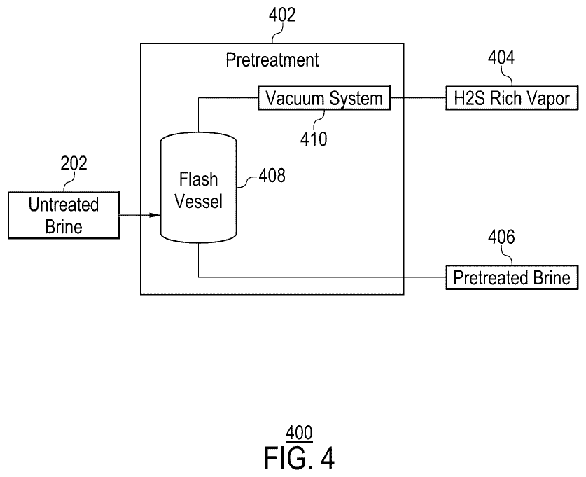

FIG. 4 is an illustration of an apparatus 400 for the removal of hydrogen sulfide from brines under vacuum. The apparatus 400 includes a pretreatment system 402 shown receiving untreated brine 202 and outputting a hydrogen sulfide (H2S) rich vapor 404 and pretreated brine 406. In various examples, the untreated brine 402 may be produced well water that also contains at least lithium. The untreated brine 202 may also contain poisons, such as hydrogen sulfide. The H2S rich vapor 404 may include water vapor containing H2S, among other poisons.

The pretreatment system 402 includes a flash vessel 408. The pretreatment system 402 also includes a vacuum system 410 coupled to the flash vessel 408. For example, the vacuum system 410 may be a liquid ring vacuum pump (LRVP), steam vacuum ejector, a liquid ejector system, or similar vacuum system.

In various embodiments, the pretreatment system 402 can receive an untreated brine 202 and generate pretreated brine 406 with a reduced concentration of hydrogen sulfide. For example, a flash separator was simulated under vacuum conditions at 70 mm Hg abs and shown to achieve a reduction of H2S from 15 ppm to less than 1 ppm in the pretreated brine 406 depending on the original concentration of H2S in the untreated brine 202. In various examples, the amount of hydrogen sulfide removed may vary depending on the concentration of hydrogen sulfide in the untreated brine 202, the operating pressure of the vacuum system 410, and the size of the flash vessel 408. In some embodiments, the size of the vessel can be optimized based on the concentration of hydrogen sulfide in the untreated brine 202, the operating pressure of the vacuum system 410, and the target concentration of hydrogen sulfide in the pretreated brine 406. Similarly, in some embodiments, the operating pressure of the vacuum system 410 can be optimized based on the concentration of hydrogen sulfide in the untreated brine 202, the size of the flash vessel 408, and the target concentration of hydrogen sulfide in the pretreated brine 406. In various embodiments, the operating conditions and target output H2S content can thus be optimized to meet DLE inlet specifications. For example, the DLE inlet specifications may include a maximum hydrogen sulfide concentration, among other specifications. In various examples, the DLE inlet specifications may also have a pH range, a TOC (total organic content) range, and temperature and pressure specifications/ranges, or any combination thereof. In this manner, the apparatus 400 may be used to increase performance and reliability of DLE units. Thus, although the increased cost of the apparatus 400 may not optimal for general degassing, the apparatus 400 may be overall more optimal when integrated with a DLE circuit due to prolonged sorbent lifetime and improved lithium selectivity and extraction.

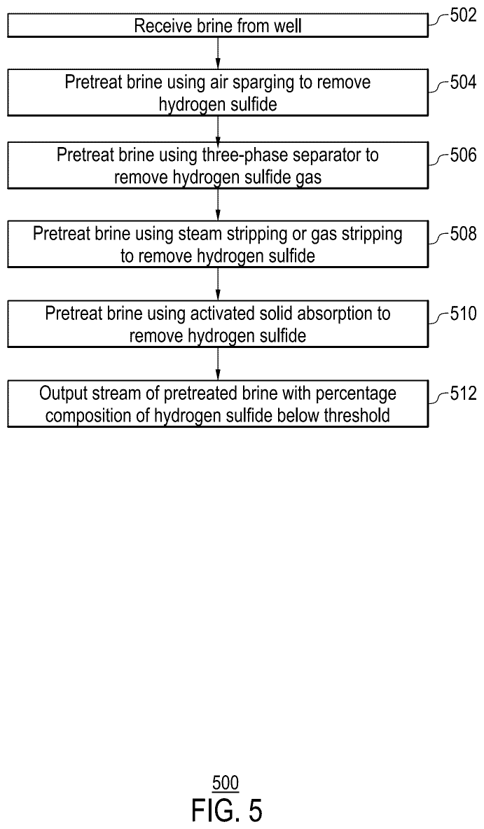

FIG. 5 is a process flow diagram of a method 500 for producing a direct lithium extraction feed. The method 500 can be implemented using any suitable pretreatment system, such as the example apparatus 200 described in FIG. 2. In various embodiments, the method 500 can be used in the pretreatment process 110 of FIG. 1.

At block 502, brine is received from a well. For example, the brine may be an untreated brine from a deep subsurface well, such as a Smackover brine. In various examples, the brine may include hydrogen sulfide, in addition to magnesium, calcium, sodium, and boron. In various examples, the untreated brine may be received as a stream from the well.

At block 504, the brine is pretreated using air sparging to remove hydrogen sulfide. In some examples, the air or other gas may be passed through a sparging tank to remove the hydrogen sulfide, in addition to knock out silica, iron, and some amount of gas.

At block 506, the brine is pretreated using a three-phase separator to remove hydrogen sulfide gas. In various embodiments, the three-phase separator may also remove any combination of natural gas, organic matter, and oils. In various embodiments, liquids may be removed from the bottom of the three-phase separator.

At block 508, the brine is treated using steam stripping or gas stripping to remove hydrogen sulfide. For example, gas stripping may be used when steam stripping is not as efficient. In various embodiments, the steam stripping or gas stripping can be designed to treat hydrogen sulfide down to levels below 10 ppm by weight. For example, the output treated brine may be treated to approximately five ppm by weight.

At block 510, the brine is treated using activated solid absorption to remove hydrogen sulfide. For example, the brine may be treated to reach a concentration of approximately five ppm by weight.

At block 512, a stream of pretreated brine with a percentage composition of hydrogen sulfide below a threshold is output. For example, the threshold may be within a range of 5-500 ppm by weight. In various examples, the output stream may be used as a DLE feed for extraction of lithium, among other metals.

The process flow diagram of FIG. 5 is not intended to indicate that the processes of the method 500 are to be executed in any particular order, or that all of the processes of the method 500 are to be included in every case. Additionally, the method 500 can include any suitable additional processing of the brine. For example, in some embodiments, the method 500 may include the use of a desander to remove solids such as sand or larger bits of rock.

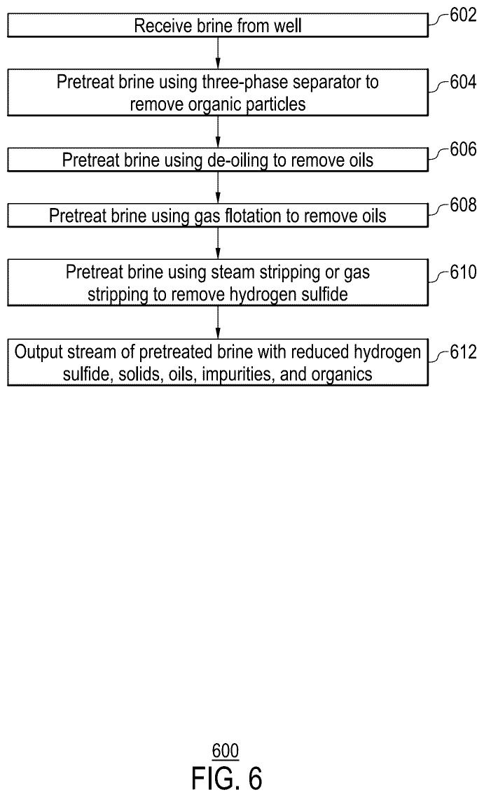

FIG. 6 is a process flow diagram of a method 600 for producing a direct lithium extraction feed, according to another embodiment. The method 600 can be implemented using any suitable pretreatment system, such as the example apparatus 300 described in FIG. 3. In various embodiments, the method 600 can be used in the pretreatment process 110 of FIG. 1.

At block 602, brine is received from a well. For example, the brine may be from a deep subsurface well, such as Smackover brine. In various examples, the brine may include hydrogen sulfide, in addition to magnesium, calcium, sodium, and boron. In various examples, the brine may be received as a stream from the well.

At block 604, the brine is pretreated using a three-phase separator to remove organic matter particles. In various embodiments, the three-phase separator may also remove any combination of hydrogen sulfide, natural gas, and oils. In various embodiments, liquids may be removed from the bottom of the three-phase separator.

At block 606, the brine is pretreated using de-oiling to remove oils. For example, the de-oiling may be an additional cyclone removal for more trace oils from brine.

At block 608, the brine is pretreated using gas flotation to remove oils. For example, gas may be bubbled through the fluid of the brine to force oils to a higher level than water.

At block 610, the brine is pretreated using stream stripping or gas stripping to remove hydrogen sulfide. For example, the stream stripping or gas stripping to remove hydrogen sulfide may be used to reduce hydrogen sulfide levels to below 10 ppm by weight. In some embodiments, gas stripping may be used instead of steam stripping if gas is more readily available and efficient.

At block 612, a stream of pretreated brine with reduced concentrations of hydrogen sulfide, solids, oils, impurities, and organic particles is output. For example, the output stream may be used as a DLE feed for extraction of lithium, among other metals.

The process flow diagram of FIG. 6 is not intended to indicate that the processes of the method 600 are to be executed in any particular order, or that all of the processes of the method 600 are to be included in every case. Additionally, the method 600 can include any suitable additional processing of the brine. For example, in some embodiments, the method 600 may include the use of a desander to remove solids such as sand or larger bits of rock. In various embodiments, precipitation may be used to remove impurities, such as barium chloride or strontium sulfate.

An example composition, which may be produced by various embodiments described above, is shown in Table 1 below:

TABLE 1
Exemplary Pretreated Brine Composition

| | | | | Min | Max |
|---|---|---|---|---|---|
| | Mass Flow | Mass | | amt | amt |
| Species | (lb/hr) | wt % | ppmw | (ppmw) | (ppmw) |
| H2O | 1,842,528.63 | 72.46 | | | |
| CO2 | 0.79 | 0.0000 | 0.31 | | |
| C4H8O4 | 10.06 | 0.0004 | 3.96 | | |
| H2S | 18.26 | 0.0007 | 7.18 | 0 | 500 |
| HCl | 370,629.96 | 14.58 | | | |
| SO3 | 214.37 | 0.0084 | 84.31 | | |
| ZnO | 0.63 | 0.0000 | 0.25 | | |
| CuO | 21.28 | 0.0008 | 8.37 | | |
| Na2O | 175,555.07 | 6.90 | | | |
| CaBr2 | 14,106.17 | 0.55 | | | |
| CaO | 105,736.34 | 4.16 | | | |
| K2O | 8,983.08 | 0.35 | | | |
| FeCl2 | 3.33 | 0.0001 | 1.31 | | |
| MgO | 10,921.76 | 0.43 | | | |
| MnO | 52.12 | 0.0020 | 20.50 | | |
| LiCl | 3,714.38 | 0.15 | | | |
| LiF | 37.82 | 0.0015 | 14.87 | | |
| BaO | 111.49 | 0.0044 | 43.85 | | |
| SrCl2 | 10,109.45 | 0.40 | | | |

In the example composition of Table 1, the amount of hydrogen sulfide in the brine stream is 7.18 ppmw, with a maximum allowable amount of 500 ppmw. In this example, this equates to about. 0007% mass concentration by weight of hydrogen sulfide remaining in the treated stream of brine.

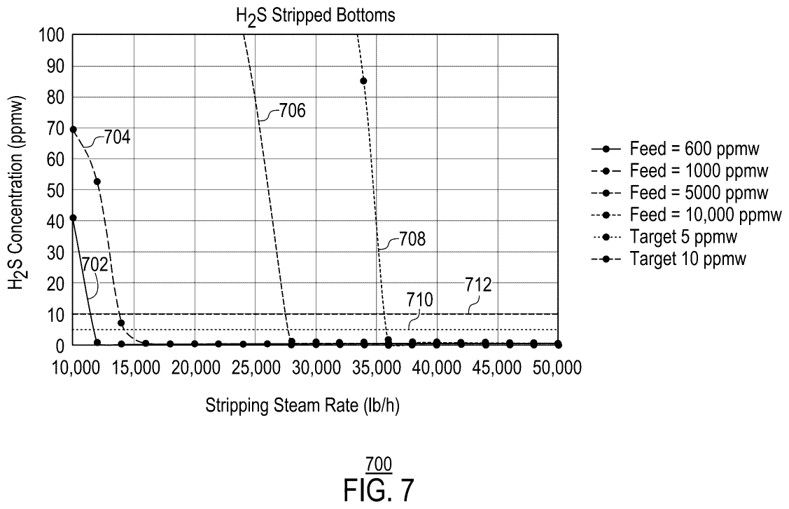

FIG. 7 is a graph 700 depicting an example stripping steam rates for various concentrations of hydrogen sulfide. A set of stripping steam requirements for various feed H2S concentrations and for varying packing depths was simulated using OLI. The hydrogen sulfide stripper used for the simulation included a nine foot inside diameter, a 20 foot height tower made of KG CMR #3 (metal), and a 14.7 PSIA operating pressure. The feed conditions for the OLI simulation included a pH of less than six, the use of a 3P simplified composition, and various brine feeds having hydrogen sulfide concentrations within a range of 600 to 10,000 ppmw.

As shown in FIG. 7, there is a steep inflection point in the stripping curves so stripping below 10 ppmw H2S is negligible in terms of stripping steam requirements. There is also about a 1% impact on stripping steam requirements.

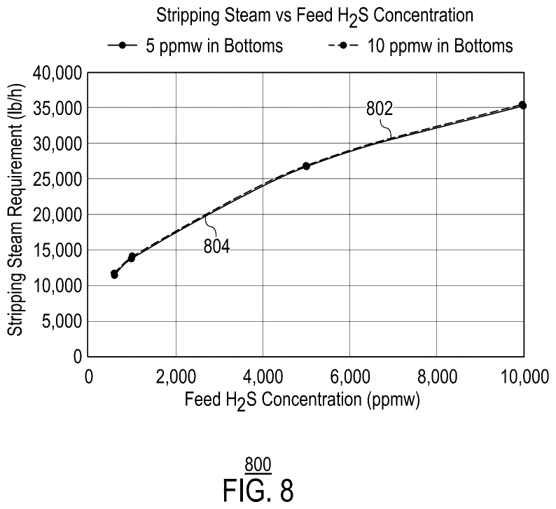

FIG. 8 is a graph 800 depicting steam stripping rates for an example packed tower. The packed tower included a 20 foot packing. Two target hydrogen sulfide concentrations (in the bottoms) of 5 ppmw 802 and 10 ppmw 804 is shown in graph 800. The feed temperature was adjusted to ambient conditions and then then preheated to the stripper. An example set of simulated values is shown in the table below:

TABLE 2
Simulated Steam Stripping Rates

| | Stripping Steam | Stripping Steam |
|---|---|---|
| Feed H₂S | Requirement for | Requirement for |
| (ppmw) | 10 ppmw (lb/h) | 5 ppmw (lb/h) |
| 600 | 11,500 | 11,680 |
| 1,000 | 13,925 | 14,052 |
| 5,000 | 26,813 | 26,969 |
| 10,000 | 35,300 | 35,586 |

As shown in FIG. 8, steam stripping hydrogen sulfide from 10 ppmw 804 to five ppmw 802 has a negligible impact on stripping steam requirements, showing only approximately a 1% impact. In particular, once in the right amount of steam range, the pH of the brine is such that almost all of the H2S is stripped off at the inflection point. Additional steam can be added to get further below 10 ppmw. The inflection point is a sharp curve down to illustrate that once stripping begins, not much additional steam is required to go below 10 or even five ppmw.

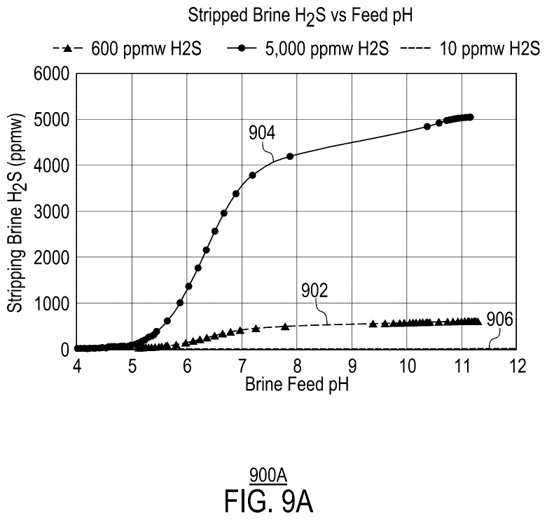

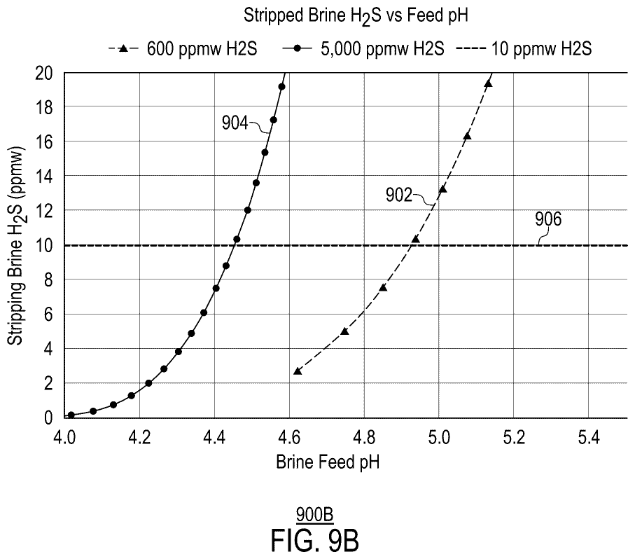

FIG. 9A is a graph 900A of brine feed pH impact on hydrogen sulfide stripability. The graph 900A was generated using an OLI simulation with a first feed basis 902 of 600 ppmw H2S untreated brine and a second feed basis 904 of 5,000 ppmw H2S untreated brine. A target specification for the brine stripper bottoms 906 of 10 ppmw H2S is indicated by a dashed arrow near the bottom of the graph 900A. In the OLI simulation used to generate graph 900A, the stripping steam rate was set to an “infinite” rate of approximately 1,000,000 lb/hr. NaOH was then added to the input feed of the OLI simulation at varying rates to result in corresponding varying pH values. As shown in FIG. 9A, pH values of 5.5 and higher resulted in significantly greater amounts of remaining hydrogen sulfide in the output stream.

FIG. 9B is a detailed graph 900B of brine feed pH impact on hydrogen sulfide stripability. The graph 900B shows a detailed portion of brine feed pH impact from pH values of 4.0 to 5.4.

As shown in FIG. 9B, according to the OLI simulation, a lower set of pH values enables larger amounts of hydrogen sulfide to be effectively stripped away. For a target brine hydrogen sulfide concentration of 10 ppmw and an input feed 902 of 600 ppmw hydrogen sulfide, the optimal input pH is about 4.43. For the same target brine hydrogen sulfide concentration of 10 ppmw and an input feed 904 of 5,000 ppmw hydrogen sulfide, the optimal input pH is about 4.9. The graphs 900A and 900B thus show that regardless of the concentration of H2S in the untreated brine feed, a feed pH of less than ˜5 should be used to promote stripping in order to achieve <10 ppmw in the stripper tower bottoms.

### EMBODIMENTS OF PRESENT TECHNIQUES

In one or more embodiments, the present techniques may be susceptible to various modifications and alternative forms, such as the following embodiments as noted in paragraphs 1 to 53:
1. A treated brine composition, the composition including a treated brine having a concentration of hydrogen sulfide within a range of 0.01 parts per million (ppm) to 500 ppm by weight.
2. The treated brine composition of paragraph 1, where the concentration of hydrogen sulfide ranges from 0 ppm by weight to 5 ppm by weight.
3. The treated brine composition of paragraph 1, where the concentration of hydrogen sulfide ranges from 5 ppm by weight to 10 ppm by weight.
4. The treated brine composition of paragraph 1, where the concentration of hydrogen sulfide ranges from 10 ppm by weight to 100 ppm by weight.
5. The treated brine composition of paragraph 1, where the concentration of hydrogen sulfide ranges from 100 ppm by weight to 500 ppm by weight.
6. The treated brine composition of any of paragraphs 1 to 5, where a concentration of lithium in the treated brine is greater than 30 milligrams per liter (mg/L).
7. The treated brine composition of any of paragraphs 1 to 5, where a concentration of lithium in the treated brine ranges from 30 milligrams per liter (mg/L) to 500 mg/L.
8. The treated brine composition of any of paragraphs 1 to 5, where a concentration of lithium in the treated brine ranges from 500 milligrams per liter (mg/L) to 1000 mg/L.
9. The treated brine composition of any of paragraphs 1 to 8, where the treated brine composition includes a stream to be used as a direct lithium extraction feed.
10. An apparatus for brine pretreatment. The apparatus includes a three-phase separator to receive a brine and generate an output liquid with reduced concentrations of hydrogen sulfide and organics. The apparatus also includes a stripper to receive the output liquid from the three-phase separator and further reduce hydrogen sulfide from the output liquid to generate a stream of pretreated brine.
11. The apparatus of paragraph 10, where the stripper includes a steam stripper:
12. The apparatus of paragraph 10, where the stripper includes a gas stripper.
13. The apparatus of any of paragraphs 10 to 12, including a de-oiler to remove oil from the brine.
14. The apparatus of any of paragraphs 10 to 13, including using activated solid absorption to reduce the hydrogen sulfide.
15. The apparatus of any of paragraphs 10 to 14, where the brine includes a deep subsurface brine.
16. The apparatus of any of paragraphs 10 to 15, where the concentration of hydrogen sulfide ranges from 0.01 ppm to less than 5 ppm by weight.
17. The apparatus of any of paragraphs 10 to 15, where the concentration of hydrogen sulfide ranges from 5 ppm by weight to 10 ppm by weight.
18. The apparatus of any of paragraphs 10 to 15, where the concentration of hydrogen sulfide ranges from 10 ppm by weight to 100 ppm by weight.
19. The apparatus of any of paragraphs 10 to 15, where the concentration of hydrogen sulfide ranges from 100 ppm by weight to 500 ppm by weight.
20. The apparatus of any of paragraphs 10 to 19, where a concentration of lithium in the stream of treated brine includes a concentration in a range from 30 milligrams per liter (mg/L) to 1000 mg/L.
21. A method of producing direct lithium extraction feeds. The method includes receiving a brine containing hydrogen sulfide. The method also includes pretreating the brine to generate a treated brine with reduced hydrogen sulfide to be used as a direct lithium extraction feed.
22. The method of paragraph 21, where pretreating the brine includes reducing the hydrogen sulfide and organics via a three-phase separator.
23. The method of paragraphs 21 or 22, where pretreating the brine includes sending the brine water through a sparging tank to pass a gas through the brine to knock out silica, iron, and an amount of gas.
24. The method of any of paragraphs 21 to 23, where pretreating the brine includes removing hydrogen sulfide gas via a sparging tank with an air injection rate and vessel size optimized based on a target composition of hydrogen sulfide for the direct lithium extraction feed.
25. The method of any of paragraphs 21 to 24, where pretreating the brine includes reducing the hydrogen sulfide using a stripper.
26. The method of any of paragraphs 21 to 25, where pretreating the brine includes de-oiling the brine via a de-oiling cyclone.
27. The method of any of paragraphs 21 to 26, where pretreating the brine includes removing solids from the brine via a desander.
28. The method of any of paragraphs 21 to 27, where pretreating the brine includes removing, via a filtration system, micron-sized particles of solids from nanometer-sized ions dissolved in the brine.
29. The method of any of paragraphs 21 to 28, where pretreating the brine includes performing a precipitation before a microfiltration and an ultrafiltration.
30. The method of any of paragraphs 21 to 29, where pretreating the brine includes processing the brine using a gas flotation system with liquid feed after a three-phase separator, where gas is flowed through the liquid to push organics to the top of a separator of the gas flotation system.
31. The method of any of paragraphs 21 to 30, where pretreating the brine includes treating the brine via a Claus-style plant to treat sour gas in the overheads of a stripper or a total gas system.
32. The method of any of paragraphs 21 to 31, where pretreating the brine includes using multiple precipitation stages in which sulfates, carbonates, or caustic are added in separate vessels.
33. The method of any of paragraphs 21 to 32, including using the treated brine in pipes with continuous processing flows to reduce corrosion of the pipes.
34. The method of any of paragraphs 21 to 33, where entrained gas does not knockout over time.
35. The method of any of paragraphs 21 to 34, where the brine also contains at least magnesium, calcium, sodium, and boron.
36. A method of using a treated brine composition. The method includes supplying a stream of treated brine composition to a process for mineral extraction, the treated brine composition having a concentration of hydrogen sulfide within a range of 0.01 ppm to 500 parts per million (ppm) by weight.
37. The method of paragraph 36, where the process for mineral extraction includes a direct lithium extraction (DLE) process.
38. The method of paragraphs 36 or 37, where the concentration of hydrogen sulfide ranges from 0.01 ppm to less than 5 ppm by weight.
39. The method of paragraphs 36 or 37, where the concentration of hydrogen sulfide ranges from 5 ppm to less than 10 ppm by weight.
40. The method of paragraphs 36 or 37, where the concentration of hydrogen sulfide ranges from 10 ppm by weight to 100 ppm by weight.
41. The method of paragraphs 36 or 37, where the concentration of hydrogen sulfide ranges from 100 ppm by weight to 500 ppm by weight.
42. The method of any of paragraphs 36, to 41 where a concentration of lithium in the treated brine composition ranges from 30 milligrams per liter (mg/L) to 1000 mg/L.
43. An apparatus for brine pretreatment. The apparatus includes a flash vessel to receive input brine containing lithium and output vapors containing hydrogen sulfide and a pretreated brine stream. The apparatus includes a vacuum system coupled to the flash vessel to remove the vapors from the flash vessel under vacuum conditions.
44. The apparatus of paragraph 43, where a size of the vessel is optimized based on a composition of the input brine and target brine composition for the pretreated brine stream.
45. The apparatus of paragraphs 43 or 44, where an operating pressure of the vacuum system is optimized based on a composition of the input brine and target brine composition for the pretreated brine stream.
46. The apparatus of any of paragraphs 43 to 45, where the pretreated brine stream is sent to a direct lithium extraction (DLE) process.
47. The apparatus of any of paragraphs 43 to 46, where a concentration of hydrogen sulfide in the pretreated brine stream is reduced within a range of 0.01 ppm to 5 ppm by weight from the concentration in the input brine.
48. The apparatus of any of paragraphs 43 to 46, where the concentration of hydrogen sulfide in the pretreated brine stream is reduced within a range of 5 ppm by weight to 10 ppm by weight from the concentration in the input brine.
49. The apparatus of any of paragraphs 43 to 46, where the concentration of hydrogen sulfide in the pretreated brine stream is reduced within a range of 10 ppm by weight to 15 ppm by weight from the concentration in the input brine.
50. The apparatus of any of paragraphs 43 to 49, where the input brine includes an untreated brine from a well.
51. The apparatus of any of paragraphs 43 to 50, where the vacuum system includes a liquid ring vacuum pump (LRVP).
52. The apparatus of paragraphs 43 to 51, where the vacuum system includes a stream vacuum ejector.
53. The apparatus of any of paragraphs 43 to 51, where the vacuum system includes a liquid ejector system.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A treated brine composition, the composition comprising a treated brine having a concentration of hydrogen sulfide within a range of 0.01 parts per million (ppm) to 500 ppm by weight.

2. The treated brine composition of claim 1, wherein the concentration of hydrogen sulfide ranges from 0.01 ppm by weight to 5 ppm by weight.

3. The treated brine composition of claim 1, wherein the concentration of hydrogen sulfide ranges from 5 ppm by weight to 10 ppm by weight.

4. The treated brine composition of claim 1, wherein the concentration of hydrogen sulfide ranges from 10 ppm by weight to 100 ppm by weight.

5. The treated brine composition of claim 1, wherein the concentration of hydrogen sulfide ranges from 100 ppm by weight to 500 ppm by weight.

6. The treated brine composition of claim 1, wherein a concentration of lithium in the treated brine is greater than 30 milligrams per liter (mg/L).

7. The treated brine composition of claim 1, wherein a concentration of lithium in the treated brine ranges from 30 milligrams per liter (mg/L) to 500 mg/L.

8. The treated brine composition of claim 1, wherein a concentration of lithium in the treated brine ranges from 500 milligrams per liter (mg/L) to 1000 mg/L.

9. The treated brine composition of claim 1, wherein the treated brine composition comprises a stream to be used as a direct lithium extraction feed.

10. An apparatus for brine pretreatment, comprising:
a three-phase separator to receive a brine and generate an output liquid with reduced concentrations of hydrogen sulfide and organics; and
a stripper to receive the output liquid from the three-phase separator and further reduce hydrogen sulfide from the output liquid to generate a stream of pretreated brine.

11. The apparatus of claim 10, wherein the stripper comprises a steam stripper.

12. The apparatus of claim 10, wherein the stripper comprises a gas stripper.

13. The apparatus of claim 10, comprising a de-oiler to remove oil from the brine.

14. The apparatus of claim 10, comprising using activated solid absorption to reduce the hydrogen sulfide.

15. The apparatus of claim 10, wherein the brine comprises a deep subsurface brine.

16. The apparatus of claim 10, wherein the concentration of hydrogen sulfide ranges from 0.01 ppm to less than 5 ppm by weight.

17. A method of producing direct lithium extraction feeds, comprising:
receiving a brine containing hydrogen sulfide; and
pretreating the brine to generate a treated brine with reduced hydrogen sulfide to be used as a direct lithium extraction feed.

18. The method of claim 17, wherein pretreating the brine comprises reducing the hydrogen sulfide and organics via a three-phase separator.

19. The method of claim 17, wherein pretreating the brine comprises sending the brine water through a sparging tank to pass a gas through the brine to knock out silica, iron, and an amount of gas.

20. The method of claim 17, wherein pretreating the brine comprises removing hydrogen sulfide gas via a sparging tank with an air injection rate and vessel size optimized based on a target composition of hydrogen sulfide for the direct lithium extraction feed.
